(19) United States
(12) Patent Application Publication
(10) Pub. No.: US 2026/0012506 A1
(43) Pub. Date: Jan. 8, 2026

(54) CONNECTION MANAGEMENT APPARATUS, METHOD, AND STORAGE MEDIUM FOR MULTI-CLUSTER-BASED CLOUD COMPUTING

(71) Applicant: ELECTRONICS AND TELECOMMUNICATIONS RESEARCH INSTITUTE, Daejeon (KR)

(72) Inventors: Dae-Won Kim, Daejeon (KR); Su-Min Jang, Daejeon (KR)

(73) Assignee: ELECTRONICS AND TELECOMMUNICATIONS RESEARCH INSTITUTE, Daejeon (KR)

(21) Appl. No.: 19/255,341

(22) Filed: Jun. 30, 2025

(30) Foreign Application Priority Data
Jul. 2, 2024 (KR) 10-2024-0086556
Jun. 13, 2025 (KR) 10-2025-0077636

(51) Int. Cl. H04L 67/1097; H04L 9/40

(52) U.S. Cl. CPC H04L 67/1097; H04L 63/029

(57) ABSTRACT

Disclosed herein are a computing management apparatus, method and storage medium for multi-cluster-based cloud computing. The connection management apparatus for multi-cluster-based cloud computing is configured to receive a network connection request between a first cluster and a second cluster, establish a gateway connection between the first cluster and the second cluster in response to the network connection request, and configure a shared repository between the first cluster and the second cluster.

### CROSS REFERENCE TO RELATED APPLICATIONS

This application claims the benefit of Korean Patent Application No. 10-2024-0086556, filed Jul. 2, 2024 and No. 10-2025-0077636, filed Jun. 13, 2025, which are hereby incorporated by reference in their entireties into this application.

### BACKGROUND OF THE INVENTION

### 1. Technical Field

The present disclosure relates to distributed cloud and edge computing technology, and more particularly to connection management technology for multi-cluster-based cloud computing.

### 2. Description of the Related Art

Currently, in order to overcome processing and transmission delays caused by the centralization of explosive data generated by user-demanded large-scale terminals at a central cloud, technologies that provide edge computing services linked with the cloud that processes data near the terminals are developed and related service systems are released. Among the systems, Kubernetes, which operates as a single cluster, is a tool designed to orchestrate and manage a container environment based on Open Container Initiative (OCI) in an integrated manner, and is the most widely used tool.

In this way, edge computing is required to process data near the location of edge devices and to perform distributed collaboration among the cloud, edge, and terminals in order to overcome processing and transmission delays caused by the centralization of massive data generated by large-scale edge terminals at the cloud.

In order to satisfy requirements such as low-latency and near-terminal processing in edge computing without relying on simple deployment based on clusters, data and application software need to move (migrate) in real time, and these have become more necessary requirements for moving bodies (e.g., autonomous vehicles, robots, drones, or the like) service.

Research into various methods is being conducted to provide services by linking distributed edge systems with a core cloud. For this, the open-source project Istio, which is Layer 7 (L7)-based service mesh technology, is being actively developed. A service mesh is a program developed to link micro services. Because this method shares a control plane on multiple networks and communication between clusters is performed through a gateway, there is no need to directly connect two networks. Further, software solutions featuring multi-network connectivity using Internet Protocol Security (IPsec) tunneling at the Layer 3 (L3) network level are actively under development.

Meanwhile, U.S. Pat. No. 11,252,159 entitled “Cognitive access control policy management in a multi-cluster container orchestration environment” discloses a method for applying access control policies unique to each user in a multi-cluster container orchestration environment.

### SUMMARY OF THE INVENTION

Accordingly, the present disclosure has been made keeping in mind the above problems occurring in the prior art, and an object of the present disclosure is to connect a cloud to an edge computing infrastructure to provide a collaboration service.

Another object of the present disclosure is to optimally manage collaboration between multiple clusters over an interconnected network.

A further object of the present disclosure is to provide high-performance distributed computing architecture for efficient collaboration between clusters.

Yet another object of the present disclosure is to provide a tunneling-based communication structure in which clusters between different domains are connected through a high-speed network.

Still another object of the present disclosure is to provide a high-performance storage structure including a memory-based global cache for high-speed data linkage between containers.

Still another object of the present disclosure is to provide a high-performance repository-based collaboration service by interconnecting storage across multiple clusters.

Still another object of the present disclosure is to provide a multi-cluster management system for efficiently controlling and operating networks and storage that are interconnected.

In accordance with an aspect of the present disclosure to accomplish the above objects, there is provided a connection management apparatus for multi-cluster-based cloud computing, including one or more processors, and a memory configured to store at least one program that is executed by the one or more processors, wherein the at least one program is configured to receive a network connection request between a first cluster and a second cluster, establish a gateway connection between the first cluster and the second cluster in response to the network connection request, and configure a shared repository between the first cluster and the second cluster.

The at least one program may be configured to establish the gateway connection through an Internet Protocol Security (IPSec)-based security tunnel.

The shared repository may mount a shared directory by deploying a Network File System (NFS) client to clusters.

The shared repository may set an in-memory file system directory as the shared directory.

The at least one program may be configured to share data by generating a global data sharing space between worker nodes of the clusters.

In accordance with another aspect of the present disclosure to accomplish the above objects, there is provided a connection management method for multi-cluster-based cloud computing, performed by a connection management apparatus for multi-cluster-based cloud computing, the connection management method including receiving a network connection request between a first cluster and a second cluster; establishing a gateway connection between the first cluster and the second cluster in response to the network connection request; and configuring a shared repository between the first cluster and the second cluster.

The establishing may include establishing the gateway connection through an Internet Protocol Security (IPSec)-based secure tunnel.

The shared repository may mount a shared directory by deploying a Network File System (NFS) client to clusters.

The shared repository may set an in-memory file system directory as the shared directory.

The configuring may include sharing data by generating a global data sharing space between worker nodes of the clusters.

In accordance with a further aspect of the present disclosure to accomplish the above objects, there is provided a storage medium for storing a computer-executable program for performing a connection management method for multi-cluster-based cloud computing, the program being configured to execute instructions including receiving a network connection request between a first cluster and a second cluster; establishing a gateway connection between the first cluster and the second cluster in response to the network connection request; and configuring a shared repository between the first cluster and the second cluster.

The establishing may include establishing the gateway connection through an Internet Protocol Security (IPSec)-based secure tunnel.

The shared repository may mount a shared directory by deploying a Network File System (NFS) client to clusters

The shared repository may set an in-memory file system directory as the shared directory.

The configuring may include sharing data by generating a global data sharing space between worker nodes of the clusters.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating a connection management system for multi-cluster-based cloud computing according to an embodiment of the present disclosure;

FIG. 2 is a diagram illustrating a method for connecting networks between clusters by a multi-cluster service broker according to an embodiment of the present disclosure;

FIG. 3 is a block diagram illustrating a multi-cluster service broker according to an embodiment of the present disclosure;

FIG. 4 is a diagram illustrating the structure of a container system based on in-memory container storage according to an embodiment of the present disclosure;

FIG. 5 is a diagram illustrating the structure of in-memory container storage according to an embodiment of the present disclosure;

FIG. 6 is a diagram illustrating a scheme for generating in-memory container storage according to an embodiment of the present disclosure;

FIG. 7 is a diagram illustrating the connection and configuration of a shared repository according to an embodiment of the present disclosure;

FIG. 8 is a diagram illustrating a multi-cluster manager applied to a robot module according to an embodiment of the present disclosure;

FIG. 9 is a diagram illustrating a tunneling network benchmark according to an embodiment of the present disclosure;

FIG. 10 is an operation flowchart illustrating a connection management method for multi-cluster-based cloud computing according to an embodiment of the present disclosure; and

FIG. 11 is a diagram illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, embodiments of the present disclosure will be described in detail with reference to the attached drawings.

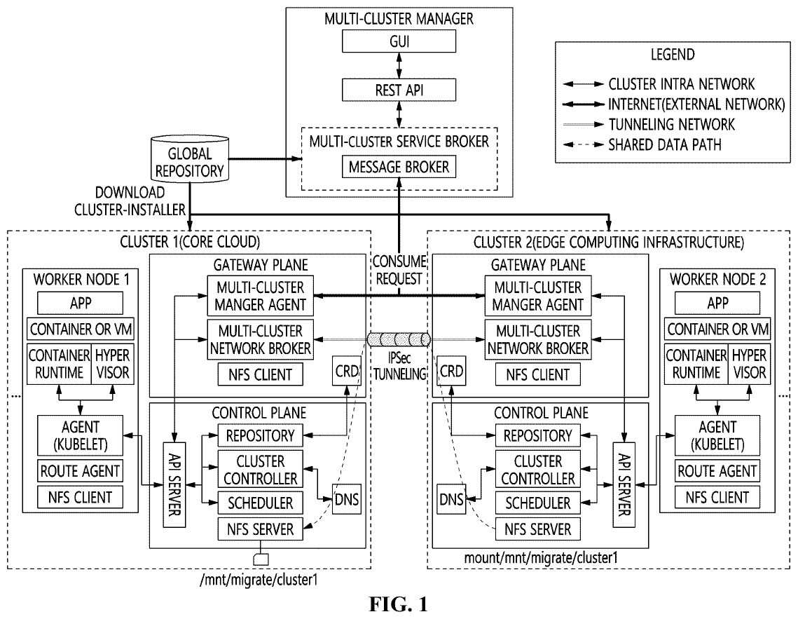

FIG. 1 is a diagram illustrating a connection management system for multi-cluster-based cloud computing according to an embodiment of the present disclosure.

Referring to FIG. 1, the connection management system for multi-cluster-based cloud computing according to an embodiment of the present disclosure may interconnect the systems of two clusters (Kubernetes: K8S), and may manage the interconnected systems. An edge computing infrastructure may be composed of computer nodes, servers, compact devices, network devices with computing capabilities, clustered nodes, and the like. In FIG. 1, cluster 1 or cluster 2 may belong to a Kubernetes environment. In another example, cluster 1 or cluster 2 may also belong to a public or private cloud environment of cloud computing environments. In FIG. 1, a control plane may be configured in infrastructures in both cloud and on-premises environments.

To support interoperability, VM or container integration agents can be deployed to platforms that natively support only one virtualization type. For example, in container-centric platforms such as Kubernetes, agents enable the orchestration of virtual machines. Similarly, in VM-based platforms such as OpenStack, agents allow for the execution and management of containerized workloads.

A multi-cluster manager may include a Graphical User Interface (GUI), a Representational State Transfer Application Programming Interface (REST API) server, and a multi-cluster service broker.

Connection management for multi-cluster-based cloud computing according to an embodiment of the present disclosure may correspond to the multi-cluster service broker.

The multi-cluster service broker may perform core-edge and edge-edge interconnection functions.

Here, the multi-cluster service broker may be one of Kubernetes (K8S) clusters having Custom Resource Definition (CRD) required to store cluster information in a repository (e.g., K8s etcd) to interconnect multiple clusters to the network, and the multi-cluster manager in which the multi-cluster service broker is installed may perform a network connection function.

The GUI may provide a user interface for managing multiple clusters.

Each cluster may include a control plane (i.e., a control node), a gateway plane (i.e., gateway node), and a worker node.

The control plane may be configured in a base cluster (K8S) master node or in a single node.

The control plane may include a Domain Name System (DNS) server, an API server, a repository, a cluster controller, and a scheduler.

The DNS server may correspond to the DNS server of the cluster network.

The API server may provide cluster-related commands and multi-cluster connection functions.

The repository may correspond to a key value data repository (e.g., K8S etcd).

The cluster controller may provide a control function for cluster management (e.g., Kubeadm or the like).

The scheduler may correspond to a scheduler for cluster load balancing.

The gateway plane may be configured within the control plane, and may be configured at any location inside the cluster.

The gateway plane may include a multi-cluster manager agent, a multi-cluster network broker, and a Network File System (NFS) client.

The multi-cluster manager agent may execute an agent program of performing commands through the multi-cluster manager and a message broker.

The multi-cluster network broker may provide network connection between clusters and a gateway (e.g., Submariner).

The multi-cluster network broker may include a broker, a route agent unit, a service discovery unit, a gateway engine unit, and a global network unit.

The broker may include Custom Resource Definition (CRD), and may exchange metadata between gateway engines (mutual discovery).

The route agent unit may perform cross-cluster traffic routing from the corresponding node to the gateway engine.

The service discovery unit may support DNS-based service discovery and service registration in the cluster.

The gateway engine unit may mange a security tunnel for network connection to other clusters (IPSec connection).

The global network unit (GlobalNet) may handle interconnection between clusters having overlapping Classless Inter-Domain Routing (CIDR) ranges.

The worker node may include an agent unit, a route agent unit, an NFS client unit, and a container runtime unit.

The agent unit may process commands for controlling the worker node from the cluster controller and manage the worker node (e.g., Kubelet).

The route agent unit may provide a router engine for connecting the inside of the cluster to the gateway.

The container runtime unit may provide an interface for running containers.

As illustrated in FIG. 1, both two clusters cluster 1 and cluster 2 may be managed by the multi-cluster manager, and multiple clusters may be managed by the multi-cluster service broker within the multi-cluster manager. To manage this, the entire system may be managed and controlled through the multi-cluster manager agent of the gateway plane of the corresponding cluster.

A global repository may be used to connect one cluster to another cluster in the state in which only one cluster is configured to implement system connections. When a physical server enables Internet connection, an operating system (OS) is installed, and the multi-cluster manager is permitted to access the physical server in order to configure an initial edge computing infrastructure, the multi-cluster manager may access the edge computing infrastructure to download a cluster installer from the global repository (e.g., GitHub or Internet-based repository), and may perform initial provisioning. The initial provisioning may proceed in the following order.

The initial provisioning may be performed to install a runtime environment.

The initial provisioning may be performed to set up the control plane.

Here, the initial provisioning may be performed to set up each cluster and connect internal cluster networks.

The initial provisioning may be performed to install the multi-cluster network broker (e.g., Submariner.io).

The initial provisioning may be performed to install and set up the Network File System (NFS) server.

Here, the initial provisioning may be performed to install and mount the server and client of the cluster node.

The initial provisioning may be performed to install the multi-cluster manager agent.

In the initial provisioning, cluster setup and network connection may not be performed in the case of a single node.

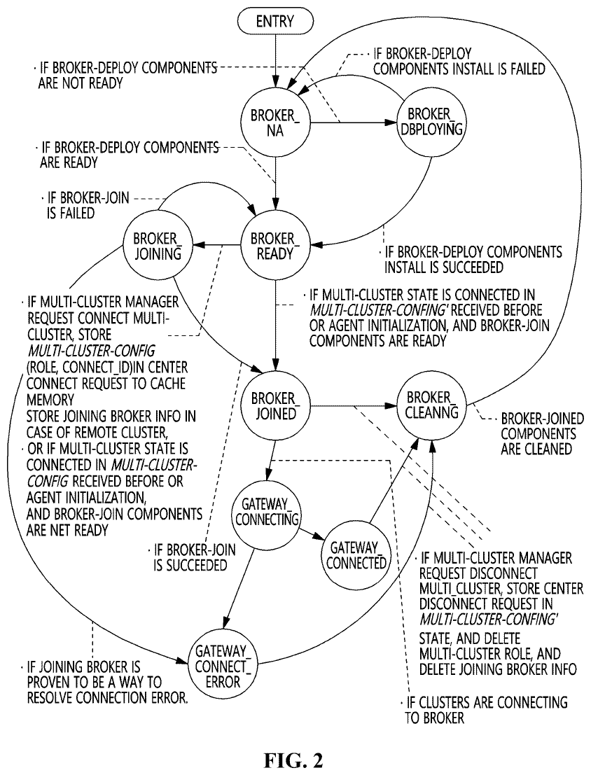

When the initial provisioning is completed, the multi-cluster service broker may connect networks between clusters through the routine such as that illustrated in the following FIG. 2.

FIG. 2 is a diagram illustrating a method for connecting networks between clusters by a multi-cluster service broker according to an embodiment of the present disclosure.

Referring to FIG. 2, the method for connecting networks between clusters by a multi-cluster service broker according to the embodiment of the present disclosure may be configured to establish connections between clusters in stages based on the deployment state of a broker component after system initialization, whether the clusters are joined, and whether gateway network connection has succeeded, and to perform retry and error recovery procedures in the event of a connection error (failure).

When the system is initialized, the broker state may enter an initial state BROKER_NA.

Here, when a broker deploy component (Broker-deploy) is not yet prepared, the system may transition to a broker deployment and installation step (state) BROKER_DEPLOYING.

When the broker deployment and installation has failed, the system may return to the initial state BROKER_NA, whereas when the broker deployment and installation has succeeded, the system may enter a broker ready state BROKER_READY.

In the BROKER_READY state, a cluster connection request may be received from the multi-cluster manager.

The cluster connection request may include multi-cluster configuration information MULTI-CLUSTER-CONFIG including a cluster role, connection information, and the like, wherein the multi-cluster configuration information may be stored in a center repository or cache memory. Here, when the cluster is a remote cluster, broker join information (Broker Join) may be stored together with the cluster connection request.

When the multi-cluster configuration information is previously received, or it is determined that the cluster state indicates that the cluster is connected before agent initialization, and when a broker join-related component is prepared, the system may transition to a broker joined state BROKER_JOINED.

When a broker join process BROKER_JOIN is not yet performed, the system may transition to a broker joining state BROKER_JOINING. When the broker join process has failed, the system may return to the broker ready state BROKER_READY. When the broker join process BROKER_JOIN has succeeded, the system may transition to a broker-joined state BROKER_JOINED.

After the broker join process BROKER_JOIN has succeeded in the broker-joined state BROKER_JOINED, the system may transition to a gateway connecting state GATEWAY_CONNECTING to perform network gateway connection between clusters. In this process, an Internet Protocol Security (IPSec)-based tunnel may be established.

When gateway connection has succeeded, the system transitions to a gateway-connected state GATEWAY_CONNECTED, and thus enables service connection and resource sharing between the clusters.

On the other hand, when gateway connection has failed, the system transitions to a gateway connection error state GATEWAY_CONNECT_ERROR. At this time, the system may perform again the broker join process as a recovery measure for the connection error, and may return to the broker-joined state BROKER_JOINED if necessary.

Meanwhile, when the connection between the clusters is terminated, the system transitions to a broker cleaning state BROKER_CLEANING. In this state, the multi-cluster role and joining broker information is deleted by the multi-cluster manager, and clusters are disconnected. Thereafter, the system returns to the broker ready state BROKER_READY, and remains in a state in which a new connection request can be received.

The cluster connection procedure based on such a broker state transition may provide the advantages of ensuring connection stability in various cluster configuration environments and flexibly responding to dynamically occurring connection failures and configuration errors.

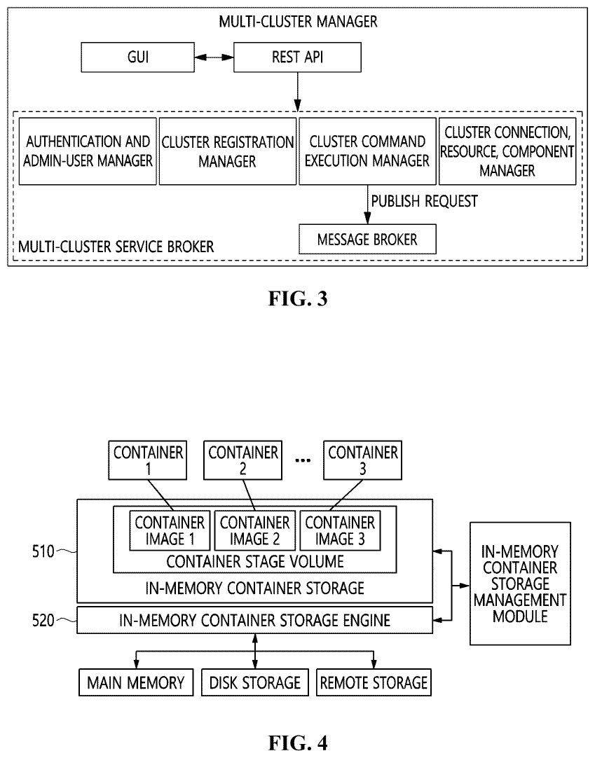

FIG. 3 is a block diagram illustrating a multi-cluster service broker according to an embodiment of the present disclosure.

Referring to FIG. 3, the multi-cluster service broker of the multi-cluster manager may include an authentication and user manager (or an authentication and administration (admin)-user manager), a cluster registration manager, a cluster command execution manager, and a cluster resource manager (or a cluster connection, resource, and component manager).

The authentication and user manager (authentication and admin-user manager) may perform registration and management of automation policies and operations to perform user registration in the system and system administration.

The cluster registration manager may receive a cluster name and a cluster description through a user web and perform registration of a new cluster.

The cluster command execution manager, which is a module that processes cluster command execution requests, may perform functions such as cluster resource control (e.g., execution or deletion of resource manifests), multi-cluster network control (e.g., deployment, joining to local or remote brokers, exporting and unexporting of cluster services), shared repository control (e.g., creation of repository in a local cluster or connection to a repository in another cluster), and control of multi-cluster network performance measurement.

The cluster resource manager may periodically monitor resource change events, the performance index of nodes constituting a cluster (CPU, memory, network), and the latency of a multi-cluster network.

When a shared repository between clusters is configured, it is favorable to configure a high-speed repository. Of course, because the system is based on an NFS, the cluster performance is primarily dependent on network performance, but the use of a repository with higher read and write speeds basically provides assistance in network performance. The present disclosure may configure and use shared storage mounted in the NFS by configuring a Solid State Drive (SSD), NVMe, a Compute Express Link (CXL)-based Dynamic Random Access Memory (DRAM) module, Processing-in-Memory (PIM), or the like as the storage. The memory of the current server system is volatile memory such as DRAM, and the repository may be configured by applying the DRAM to a tmpfs file system, but the present disclosure may propose and use additional memory using DRAM together with the memory.

FIG. 4 is a diagram illustrating the structure of a container system based on in-memory container storage according to an embodiment of the present disclosure.

Referring to FIG. 4, the container system based on the in-memory container storage according to the present disclosure may include in-memory container storage 510, an in-memory container storage engine 520, main memory, disk storage, and a remote storage.

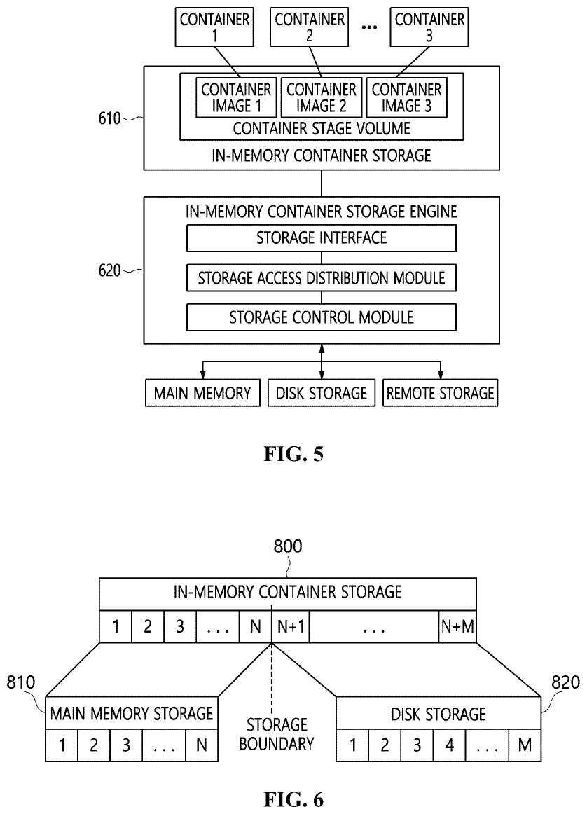

FIG. 5 is a diagram illustrating an example of the structure of in-memory container storage according to an embodiment of the present disclosure.

Hereinafter, the structure and operation flow of the in-memory container storage according to the present disclosure will be described in detail with reference to FIG. 5.

First, a container may generate in-memory container storage 610, which is storage in main memory having nonvolatile characteristics, and may configure a storage volume for the container in the in-memory container storage 610.

The container may generate and operate a container storage volume, which is the volume of a file system (example of a docker is/var/lib/docker) in which the container runs in the in-memory container storage 610. Therefore, a container access command generated by the container may be transferred to the in-memory container storage 610.

An in-memory container storage engine 620 may generate single shape in-memory container storage 610 by unifying the main memory, disk storage, and remote storage. Also, the in-memory container storage engine 620 may process a disk access command by utilizing the main memory, the disk storage, and the remote storage in an integrated manner.

In this case, the in-memory container storage 610 may be operated, without separate modification, by providing a standard block storage-format interface through the in-memory container storage engine 620.

FIG. 6 is a diagram illustrating a scheme for generating in-memory container storage according to an embodiment of the present disclosure.

Referring to FIG. 6, a method for generating single hybrid-type in-memory container storage 800 by unifying main memory storage 810 with disk storage 820 is illustrated.

The in-memory container storage 800 may provide a standard block storage format, and may be generated by mapping the area of the main memory storage 810 to the head portion of the storage and mapping the area of the disk storage 820 to the tail portion of the storage.

For example, the area corresponding to block IDs 1 to N of the main memory storage 810 may be mapped to the area corresponding to block IDs 1 to N of the in-memory container storage 800. Further, the area corresponding to block IDs 1 to M of the disk storage 820 may be mapped to the area corresponding to block IDs N+1 to N+M of the in-memory container storage 800. Here, a storage boundary for distinguishing the area of the main memory storage 810 from the area of the disk storage 820 may be set between the block IDs N and N+1 of the in-memory container storage 800.

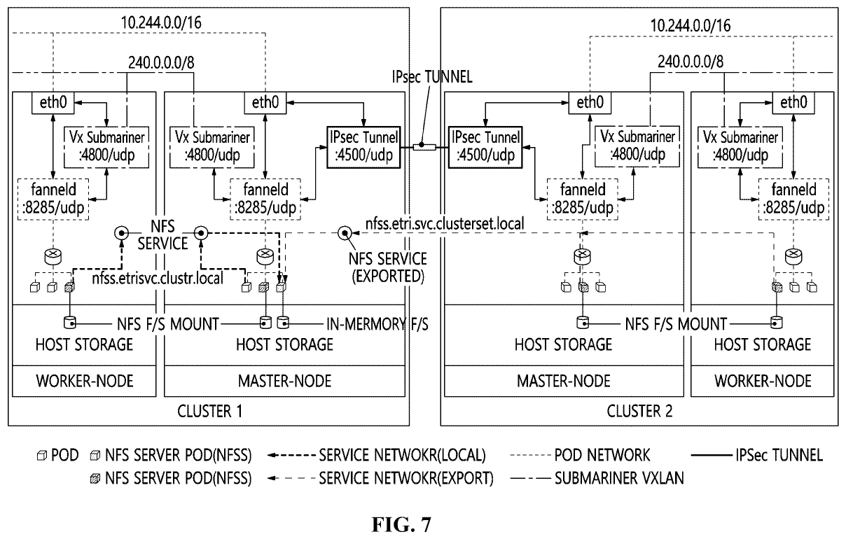

FIG. 7 is a diagram illustrating the connection and configuration of a shared repository according to an embodiment of the present disclosure.

Referring to FIG. 7, the design of an NFS-based multi-cluster shared repository of an in-memory file system is illustrated. First, cluster 1 (cluster name: north-cls) and cluster 2 (cluster name: south-cls) are interconnected through Internet Protocol Security (IPsec) tunnel-based pod networks of Submariner. Cluster 1 deploys an NFS server pod (deployment name: nfs-server-north-cls, namespace: edge) and a service (service name: nfs-server-north-cls, namespace: edge, service type: ClusterIP) to a local cluster.

Here, the NFS server pod (i.e., nfss pod) may function as a high-speed repository in a multi-cluster environment by setting an in-memory file system directory configured by a host (i.e., master node of the north cluster) as an NFS service directory.

When cluster 1 deploys the NFS client (pod name: nfs-client-north-cls, namespace: edge) to all nodes, the NFS client pod may access the NFS server via the domain address “nfs-server-north-cls.edge.svc.cluster.local” through the DNS of the cluster. All NFS client pods may be connected to the NFS server to mount (F/S type: nfs) a shared directory (“/mnt/nfs-vol/north-cls”) as the file system of their own local nodes, and thus all NORTH cluster nodes may share the file system through the “/mnt/shared/north-cls” directory.

Next, cluster 1 allows cluster 2 to access the service of the NFS server using the service export function of the multi-cluster network broker. When the export of the nfss service of the cluster 1 has succeeded, the service discovery unit of multi-cluster network broker operating in cluster 2 adds nfss service access domain of cluster 1, which is exported, to the DNS of cluster 2. All pods and services of cluster 2 may access the NFS server of cluster 1 via the address “nfs-server-north-cls.edge.svc.clusterset.local”.

Next, cluster 2 may deploy the NFS client (NFS server address: nfs-server-north-cls.edge.svc.clusterset.local, mount directory:/mnt/nfs-vol/north-cls, F/S type: nfs) to all nodes, thus allowing all nodes in cluster 2 to share the file system with cluster 1 through the directory “/mnt/shared/north-cls” of a host.

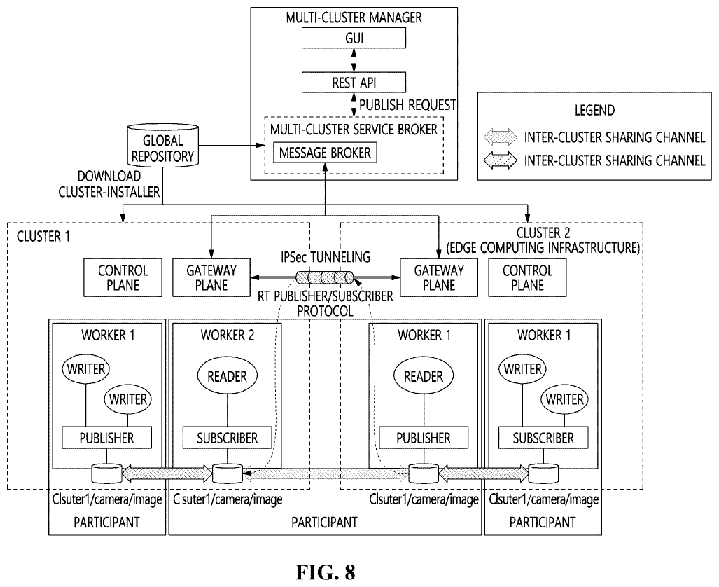

FIG. 8 is a diagram illustrating a multi-cluster manager applied to a robot module according to an embodiment of the present disclosure.

Referring to FIG. 8, a data distribution service (e.g., Robot Operating System (ROS) Data Distribution Service (DDS)) in which a robot module (e.g., a module implemented using a robot operating system (ROS)) is applied to multiple clusters (e.g., ROS DDS) may be illustrated.

In the present disclosure, the multiple clusters may support the cases of use of the robot module and the management of data transmission.

The robot module may be set in multiple clusters, and thus communication between clusters (i.e., inter-cluster communication) may be performed using a strong distribution system function of a data distribution service.

The data distribution service may provide a protocol by which data can be efficiently deployed between various nodes on the network, and may establish communication between the modules of multiple clusters based on the protocol.

The data distribution service may support a wide application from a small-sized embedded system to an infrastructure-level large-scale system, and may also support a distributed real-time embedded system.

The data distribution service may provide efficient data transmission between processes even across distributed heterogeneous platforms. It can be seen that the shared repository presented in the present disclosure may be applied to the robot module, as illustrated in FIG. 8.

Each worker node may generate a “global data sharing space” that can be accessed by an application (e.g., writer or reader). In the data distribution service, each process (publisher) that publishes data or process (subscriber) that subscribes to data is referred to as a participant that corresponds to a robot module (e.g., node of ROS). The participant may read and write data from and to a global data sharing space through an input interface. As illustrated in FIG. 8, a robot system may include participants, publishers, subscribers, writers, readers, and messages (e.g., DomainParticipant, Publisher, Subscriber, DataWriter, DataReader, and Topic of ROS). Data transmission between processes may be executed based on the Quality of Service (QOS) policies.

Each participant may be an application that performs communication in a DDS network, and may include an application that performs communication across domains. DomainParticipant of ROS2 may perform communication between applications only in the same domain, but the present disclosure may enable communication to be performed only in different domains between clusters.

Each publisher is an entity that takes charge of data publication. A publisher that manages one or more writers may send data related to one or more themes.

Each subscriber may support data so that published data is received and used. The subscriber operates on behalf of one or more readers.

Each writer is an entity that needs to be used in participant so as to publish data through the publisher. Each writer may publish a designated type of data.

Each reader is an entity connected to the subscriber. When the reader is used, the participant may receive data that is to match the type of writer and access the data.

Each channel may be used to identify each data entity between the writer and the reader. Each message may be defined by a name and a data type. (e.g., Topic of ROS)

The present disclosure may perform connection between clusters in domains (e.g., IPSec tunneling, VPN, virtual router, etc.) and configure a high-speed shared repository in order to transmit and share data between participants in different domains across multiple clusters, thus realizing more efficient message transmission.

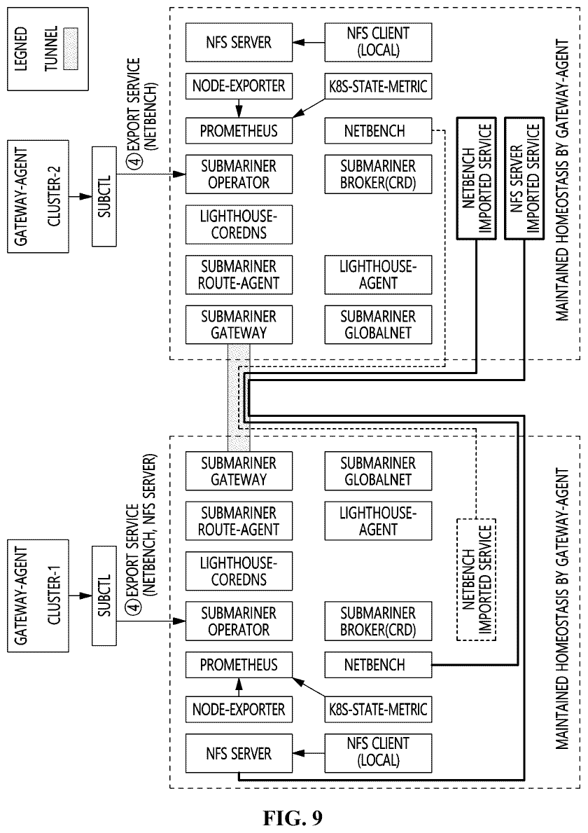

FIG. 9 is a diagram illustrating a tunneling network benchmark according to an embodiment of the present disclosure.

Referring to FIG. 9, after connection of multiple clusters is completed, a network bench NETBENCH for measuring network throughput between the two clusters is connected to a tunnel network.

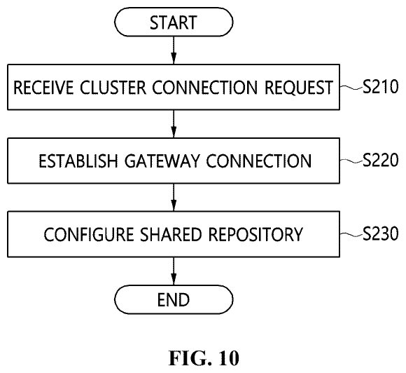

FIG. 10 is an operation flowchart illustrating a connection management method for multi-cluster-based cloud computing according to an embodiment of the present disclosure.

Referring to FIG. 10, the connection management method for multi-cluster-based cloud computing according to the embodiment of the present disclosure may receive a cluster connection request at step S210.

That is, at step S210, a network connection request between a first cluster and a second cluster may be received.

Also, the connection management method for multi-cluster-based cloud computing according to the embodiment of the present disclosure may establish gateway connection at step S220.

That is, at step S220, in response to the network connection request, gateway connection between the first cluster and the second cluster may be established.

Here, at step S220, the gateway connection may be established through an IPSec-based security tunnel.

Further, the connection management method for multi-cluster-based cloud computing according to the embodiment of the present disclosure may configure a shared repository at step S230.

That is, at step S230, the shared repository between the first cluster and the second cluster may be configured.

Here, the shared repository may mount a shared directory by deploying an NFS client to each cluster.

Here, the shared repository may set an in-memory file system directory as the shared directory.

Here, at step S230, data may be shared by generating a global data sharing space between worker nodes of the clusters.

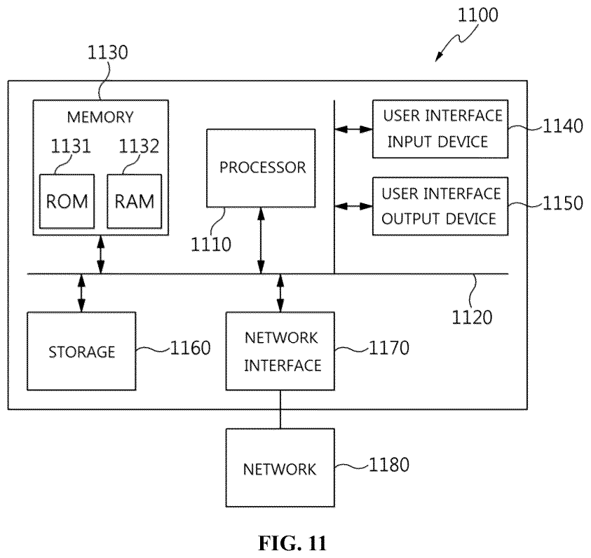

FIG. 11 is a diagram illustrating a computer system according to an embodiment of the present disclosure.

Referring to FIG. 11, a connection management apparatus for multi-cluster-based cloud computing according to an embodiment of the present disclosure may be implemented in a computer system 1100 such as a computer-readable storage medium. As illustrated in FIG. 11, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

A connection management apparatus for multi-cluster-based cloud computing according to an embodiment of the present disclosure may include one or more processors 1110, and memory 1130 configured to store at least one program that is executed by the one or more processors 1110, wherein the at least one program is configured to receive a network connection request between a first cluster and a second cluster, establish a gateway connection between the first cluster and the second cluster in response to the network connection request, and configure a shared repository between the first cluster and the second cluster.

Here, the at least one program may be configured to establish the gateway connection through an Internet Protocol Security (IPSec)-based security tunnel.

Here, the shared repository may mount a shared directory by deploying a Network File System (NFS) client to clusters.

Here, the shared repository may set an in-memory file system directory as the shared directory.

Here, the at least one program may be configured to share data by generating a global data sharing space between worker nodes of the clusters.

A storage medium for storing a computer-executable program for performing a connection management method for multi-cluster-based cloud computing according to an embodiment of the present disclosure is provided, wherein the program is configured to execute instructions including receiving a network connection request between a first cluster and a second cluster, establishing a gateway connection between the first cluster and the second cluster in response to the network connection request, and configuring a shared repository between the first cluster and the second cluster.

Here, the establishing may include establishing the gateway connection through an Internet Protocol Security (IPSec)-based secure tunnel.

Here, the shared repository may mount a shared directory by deploying a Network File System (NFS) client to clusters.

Here, the shared repository may set an in-memory file system directory as the shared directory.

Here, the configuring may include sharing data by generating a global data sharing space between worker nodes of the clusters.

The present disclosure may connect a cloud to an edge computing infrastructure to provide a collaboration service.

Further, the present disclosure may optimally manage collaboration between multiple clusters over an interconnected network.

Furthermore, the present disclosure may provide high-performance distributed computing architecture for efficient collaboration between clusters.

Furthermore, the present disclosure may provide a tunneling-based communication structure in which clusters between different domains are connected through a high-speed network.

Furthermore, the present disclosure may provide a high-performance storage structure including a memory-based global cache for high-speed data linkage between containers.

Furthermore, the present disclosure may provide a high-performance repository-based collaboration service by interconnecting storage across multiple clusters.

Furthermore, the present disclosure may provide a multi-cluster management system for efficiently controlling and operating networks and a storage that are interconnected.

As described above, in the connection management apparatus, method and storage medium for multi-cluster-based cloud computing according to the present disclosure, the configurations and schemes in the above-described embodiments are not limitedly applied, and some or all of the above embodiments can be selectively combined and configured so that various modifications are possible.

What is claimed is:

1. A connection management apparatus for multi-cluster-based cloud computing, comprising:
one or more processors; and
a memory configured to store at least one program that is executed by the one or more processors,
wherein the at least one program is configured to:
receive a network connection request between a first cluster and a second cluster,
establish a gateway connection between the first cluster and the second cluster in response to the network connection request, and
configure a shared repository between the first cluster and the second cluster.

2. The connection management apparatus of claim 1, wherein the at least one program is configured to establish the gateway connection through an Internet Protocol Security (IPSec)-based security tunnel.

3. The connection management apparatus of claim 1, wherein the shared repository mounts a shared directory by deploying a Network File System (NFS) client to clusters.

4. The connection management apparatus of claim 3, wherein the shared repository sets an in-memory file system directory as the shared directory.

5. The connection management apparatus of claim 1, wherein the at least one program is configured to share data by generating a global data sharing space between worker nodes of the clusters.

6. A connection management method for multi-cluster-based cloud computing, performed by a connection management apparatus for multi-cluster-based cloud computing, the connection management method comprising:
receiving a network connection request between a first cluster and a second cluster;
establishing a gateway connection between the first cluster and the second cluster in response to the network connection request; and
configuring a shared repository between the first cluster and the second cluster.

7. The connection management method of claim 6, wherein the establishing comprises:
establishing the gateway connection through an Internet Protocol Security (IPSec)-based secure tunnel.

8. The connection management method of claim 6, wherein the shared repository mounts a shared directory by deploying a Network File System (NFS) client to clusters.

9. The connection management method of claim 8, wherein the shared repository sets an in-memory file system directory as the shared directory.

10. The connection management method of claim 6, wherein the configuring comprises:
sharing data by generating a global data sharing space between worker nodes of the clusters.

11. A storage medium for storing a computer-executable program for performing a connection management method for multi-cluster-based cloud computing, the program being configured to execute instructions comprising:
receiving a network connection request between a first cluster and a second cluster;
establishing a gateway connection between the first cluster and the second cluster in response to the network connection request; and
configuring a shared repository between the first cluster and the second cluster.

12. The storage medium of claim 11, wherein the establishing comprises:
establishing the gateway connection through an Internet Protocol Security (IPSec)-based secure tunnel.

13. The storage medium of claim 11, wherein the shared repository mounts a shared directory by deploying a Network File System (NFS) client to clusters.

14. The storage medium of claim 13, wherein the shared repository sets an in-memory file system directory as the shared directory.

15. The storage medium of claim 11, wherein the configuring comprises:
sharing data by generating a global data sharing space between worker nodes of the clusters.
